(19) United States
(12) Patent Application Publication
(10) Pub. No.: US 2023/0099040 A1
(43) Pub. Date: Mar. 30, 2023

(54) OILY FOOD MATERIAL FOR COMBINATION USE, AND METHOD FOR PRODUCING SAME

(71) Applicant: FUJI OIL HOLDINGS INC., Osaka (JP)

(72) Inventor: hideki MOTOIKE, Ibaraki (JP)

(73) Assignee: FUJI OIL HOLDINGS INC., Osaka (JP)

(21) Appl. No.: 17/802,534

(22) PCT Filed: Mar. 1, 2021
(86) PCT No.: PCT/JP2021/007636

§ 371 Date: Aug. 26, 2022

(30) Foreign Application Priority Data
Mar. 4, 2020 (JP) 2020-036766

(51) Int. Cl. A23G 1/36; A23G 9/32

(52) U.S. Cl. CPC A23G 1/36; A23G 9/32

(57) ABSTRACT

Provided is a water-in-oil-type emulsion including a fat-free cacao solid material in an amount of 8.5 to 25% by weight, cacao mass and cocoa each having a pH value of 6.8 or less in a total amount of 10 to 40% by weight, an oil or fat in an amount of 30 to 55% by weight, water in an amount of 5 to 26% by weight, and at least one emulsifying agent selected from lecithin and a polyglycerol condensed ricinolate in a total amount of 1 to 2.5% by weight, whereby it becomes possible to provide a water-containing chocolate product which remains unchanged with respect to the physical properties thereof even when the water-containing chocolate product undergoes a sterilization treatment that is essential for the delivery thereof.

### TECHNICAL FIELD

The present invention relates to a method for producing a water-in-oil-type water-containing chocolate product for combination use with other foods, particularly a frozen sweet.

### BACKGROUND ART

There is a category of chocolate-like foods called a water-containing chocolate as the related art.

One of them is what is called a raw chocolate into which an emulsion as fresh cream is compounded. It is a popular commercial product in the market because a fresh texture can be enjoyed due to an aqueous component contained therein.

Such a water-containing chocolate is often used in combination with other foods such as breads, cakes, confections, and frozen sweets, while also being eaten alone. There is a greater product variety of the other foods than those in which it is eaten alone, and there is a great demand from the market.

Among them, when the water-containing chocolate is used for an ice coating chocolate of which the main purpose is to be combined with frozen sweets, the soft texture characteristic of a water-containing material may be lost due to the generation of ice crystals, and the like, or the workability may become worse than in the case of using the ice coating chocolate which is a water-free product. In addition, in the case of products that require long-term storage stability, a sterilization step is required at the time of distribution, which is likely to cause the aggregation of a milk solid material, and the accompanying increase in viscosity, deterioration in texture, and the like, thereby making the degree of difficulty thereof high, as compared to the case of using the ice coating chocolate which is a water-free product.

For example, in the related art, a method for producing a chocolate for ice coating which is obtained by uniformly mixing cocoa and/or cacao mass, sugar, and an oil and fat as main components by a conventional method has been disclosed, where the method for producing a chocolate for ice coating is characterized by emulsifying the above-mentioned main components and liquid sugar using an emulsifying agent, in which a sensation in the mouth is pleasant and a drying time after coating is fast, cracking does not occur, and a “watery” (plasticization) phenomenon of the chocolate itself due to incorporation of a water content is unlikely to occur (Cited Reference 1).

In addition, a method for producing a water-containing chocolate product, which is characterized by mixing a chocolate dough that has been subjected to roll conching according to a conventional method, and an aqueous component in the presence of a low HLB sucrose fatty acid ester in which a major linked fatty acid has 20 to 26 carbon atoms to perform emulsification into a water-in-oil-type, is disclosed, in which, as compared to conventional ganache, the emulsified state is extremely stable and the water-containing chocolate product can be used extremely advantageously for coating frozen sweets and the like (Cited Reference 2).

However, although the quality required by these inventions can cope with a combination with frozen sweets, coping with an increase in viscosity and a sterilization step is still insufficient.

In addition, a method for producing a water-containing chocolate, which is characterized by mixing a chocolate base containing a saccharide having a higher solubility in water than sugar, a sucrose fatty acid ester having an HLB value of 3 or less and a major linked fatty acid having 20 to 26 carbon atoms, and oils and fats, and an aqueous component to perform emulsification into a water-in-oil-type, is disclosed, by which a water-containing chocolate can be produced as the effect thereof, in which the water-containing chocolate has no roughness or increase in viscosity due to the aggregation of a solid material even when a water content is added, has good workability, and has good flavor (Cited Reference 3). In addition, a method for producing a water-in-oil-type water-containing chocolate product is disclosed, the method having the effect of obtaining a chocolate having no roughness or increase in viscosity due to the aggregation of a solid material, having good workability, and having good flavor by setting a phospholipid content to 60% by weight or more, and adding 0.05% by weight to 5.0% by weight of fractionated lecithin, in which a phosphatidylcholine content in the total phospholipids is 50% by weight or more, with respect to the total amount of the water-containing chocolate, when a chocolate dough and an aqueous component are mixed to produce the water-in-oil-type water-containing chocolate product (Cited Reference 4).

However, although there is a disclosure regarding the effect on physical properties such as reduction of roughness, this effect is not sufficient in frozen sweets.

Furthermore, a method for producing a water-in-oil-type water-containing chocolate product is disclosed, where the water-containing chocolate product which can be added to a chocolate dough as it is without subjecting a water-containing component to any processing, which has the same physical properties as common chocolates, thereby making emulsification stable, and which has good flavor can be easily produced by using each of a sucrose fatty acid ester having an HLB value of 3 or less and a major constituent fatty acid having 16 to 18 carbon atoms, and a polyglycerol condensed ricinolate in the range of 0.05% by weight to 5.0% by weight with respect to the chocolate dough, when the chocolate dough and an aqueous component are mixed to produce the water-in-oil-type water-containing chocolate product (Cited Reference 5).

However, although this invention discloses that a polyglycerol condensed ricinolate is added to a general-purpose water-in-oil-type emulsion, the suitability for usage of a combination with frozen sweets and usage of application to frozen sweets alone is not particularly suggested.

As described above, there may have been a certain effect in solving each of the problems, but in combination with frozen sweets in the present invention, one, which has a sufficient effect on adverse influences such as a sufficient sterilization step with respect to physical properties while keeping a soft texture characteristic of a water-containing material, has not been found yet.

### CITATION LIST

### Patent Literature

Patent Literature 1: Japanese Patent Laid-Open No. S51-106763

Patent Literature 2: Japanese Patent Laid-Open No. S59-71643

Patent Literature 3: Japanese Patent Laid-Open No. 116-245704

Patent Literature 4: Japanese Patent Laid-Open No. 118-70776

Patent Literature 5: Japanese Patent Laid-Open No. H11-243860

### SUMMARY OF INVENTION

### Technical Problem

The present invention relates to a method for producing a water-in-oil-type water-containing chocolate product for combination use with other foods, and an objective thereof is to provide a method for producing a water-containing chocolate product for combination use particularly with a frozen sweet, the water-containing chocolate product having the same level of workability as that in the case where a water-free product is used while keeping a soft texture characteristic of a water-containing material, and remaining unchanged with respect to the physical properties thereof even when the water-containing chocolate product undergoes sterilization that is essential for the delivery thereof.

Furthermore, a chocolate product that is unlikely to be cracked when being coated onto the entire surface of dairy-free frozen desserts and other frozen sweets can also be provided.

### Solution to Problem

The inventors of the present invention conducted various examinations to achieve the above-mentioned objective, and completed the present invention by obtaining findings that the above-mentioned objective can be achieved by using an oily food material for combination use with a frozen sweet which is a water-in-oil-type emulsion containing: a fat-free cacao solid material in an amount of 8.5 to 25% by weight; cacao mass and cocoa each having a pH of 6.8 or less in a total amount of 10 to 40% by weight; an oil or fat in an amount of 30 to 55% by weight; water in an amount of 5 to 26% by weight; and an emulsifying agent of one or more kinds selected from lecithin or a polyglycerol condensed ricinolate in a total amount of 1 to 2.5% by weight.

That is, the present invention is as follows.

(1) An oily food material for combination use which is a water-in-oil-type emulsion containing: a fat-free cacao solid material in an amount of 8.5 to 25% by weight; cacao mass and cocoa each having a pH of 6.8 or less in a total amount of 10 to 40% by weight; an oil or fat in an amount of 30 to 55% by weight; water in an amount of 5 to 26% by weight; and an emulsifying agent of one or more kinds selected from lecithin and/or a polyglycerol condensed ricinolate in a total amount of 1 to 2.5% by weight.

(2) The oily food material for combination use according to (1), in which a viscosity is 100 to 3000 cP (BM type viscometer No. 2 or No. 3, measurement at 30 rpm/40° C.).

(3) The oily food material for combination use according to any one of (1) or (2), in which the oily food material for combination use has a pH of 4.5 to 6.2, has a fat-free milk solid material of 7.5% by weight or less, and is for combination use with a frozen sweet.

(4) A method for producing the oily food material for combination use with a frozen sweet according to (1) to (3), the method including a sterilization step at 68° C. or higher for 30 minutes or longer after emulsification.

(5) A method for producing a frozen sweet-combined food obtained by combining the oily food material for combination use with a frozen sweet according to (4) with a frozen sweet.

Furthermore, in other words, the present invention is as follows.

(1) An oily food material for combination use which is a water-in-oil-type emulsion containing: a fat-free cacao solid material in an amount of 8.5 to 25% by weight; cacao mass and cocoa each having a pH of 6.8 or less in a total amount of 10 to 40% by weight; an oil or fat in an amount of 30 to 55% by weight; water in an amount of 5 to 25% by weight; and an emulsifying agent of one or more kinds selected from lecithin and/or a polyglycerol condensed ricinolate in a total amount of 1 to 2.5% by weight.

(2) The oily food material for combination use according to (1), in which a viscosity is 100 to 2000 cP (BM type viscometer No. 2 or No. 3, measurement at 30 rpm/40° C.).

(3) The oily food material for combination use according to any one of (1) or (2), in which the oily food material for combination use has a pH of 4.5 to 6.0, has a fat-free milk solid material of 7.5% by weight or less, and is for combination use with a frozen sweet.

(4) A method for producing the oily food material for combination use with a frozen sweet according to (1) to (3), the method including a sterilization step at 68° C. or higher for 30 minutes or longer after emulsification.

(5) A method for producing a frozen sweet-combined food obtained by combining the oily food material for combination use with a frozen sweet according to (4) with a frozen sweet.

### Advantageous Effects of Invention

According to the present invention, a water-in-oil-type water-containing chocolate product for combination use with other foods, particularly a frozen sweet, can be provided, the water-containing chocolate product having the same level of workability as that in the case where a water-free product is used while keeping a soft texture characteristic of a water-containing material, and remaining unchanged with respect to the physical properties thereof even when the water-containing chocolate product undergoes sterilization that is essential for the delivery thereof.

In addition, this enables to embody a new form of a frozen sweet that can be coated onto the entire surface of dairy-free frozen desserts and other frozen sweets without cracking.

### DESCRIPTION OF EMBODIMENTS

Hereinafter, the present invention will be specifically described.

(Oily Food Material for Combination Use)

In the present invention, an oily food material for combination use is an oily food material characterized in that it is used in combination with other foods.

The combination referred to herein is not particularly limited, but may include application or kneading.

The other foods are not particularly limited as long as they are foods, but examples include bakery doughs of doughnuts, breads, pies, cream puffs, or the like, and baked products thereof; confections such as biscuits, cookies, and pretzels; a so-called “puffed confection” made by heating and pressurizing grains such as wheat and rice and thereafter swelling them by applying rapid depressurization treatment; potato chips made by slicing and frying potatoes or potato snacks made by shaping and frying (molding) cereal flours and starches containing potatoes; and marshmallows, meringues, frozen sweets, and the like made by baking an egg white-containing aerated substance with sugars and the like. A food material that is limitedly used by adopting these other foods and the above-mentioned combination methods is referred to as the oily food material for combination use.

(Oily Food Material for Combination Use with Frozen Sweet)

In the present invention, an oily food material for combination use with a frozen sweet is an oily food material characterized in that it is used in combination particularly with a frozen sweet among the above-mentioned other foods for combination use.

The frozen sweet refers to a food that is stored in a frozen state and a chilled state to be eaten, and examples thereof include, but are not limited to, ice cream, soft serve ice cream, popsicles, frozen yogurt, sherbet, and dairy-free frozen desserts.

A food material that is limitedly used by adopting the above-mentioned frozen sweets and the above-mentioned combination methods is referred to as the oily food material for combination use with a frozen sweet.

(Water-In-Oil-Type Emulsion)

The oily food material is a water-in-oil-type emulsion, and it is preferable that the component of the oily food material have an oil and fat in the amount of 30 to 55% by weight, desirably 35 to 55% by weight, and more desirably 45 to 50% by weight. In addition, water is contained in the amount of 5 to 26% by weight, desirably 10 to 20% by weight. Furthermore, the total amount of cacao mass and cocoa is 10 to 40% by weight, desirably 10 to 35% by weight, and more desirably 15 to 30% by weight. Furthermore, the emulsified system of the emulsion can be confirmed by an electrical conduction method (whether conductive or not).

It is preferable that the viscosity of the oily food material for combination use be desirably within the range of 100 to 3000 cP (BM type viscometer No. 2 or No. 3, measurement at 30 rpm/40° C.), and the viscosity be more desirably within 100 to 1500 cP, and further desirably within 200 to 1000 cP.

When it is not within this range, there are the following problems: for application and coating usage, it cannot evenly cover the surface of a product, and it drips after covering; for kneading usage, it cannot be uniformly dispersed throughout a product, thereby impairing the commercial product value; and the like.

(Basic Ingredients)

The cacao mass used in the present invention is obtained by grinding cacao nibs (endosperm portion) obtained by roasting and peeling cacao beans, and means all of what is also called cacao liquor.

Cocoa is a part excluding cocoa butter, which is an oil and fat part, from cacao mass, and is also called cocoa powder. In addition, there are roughly two types of methods for producing cocoa, which are the Broma process and the Dutch process, and due to neutralization with alkali used in the production step thereof, cocoa (referred to as alkaline cocoa) obtained by the Dutch process shows a higher pH than that of cocoa (referred to as natural cocoa) obtained by the Broma process. Generally, the pH of the natural cocoa is around 5.5, whereas the pH of the alkaline cocoa is 6.8 or more.

In the invention of the present application, because the influence of the pH of cocoa on the stability of emulsification is greater than the pH of the entire aqueous phase, it is preferable that the pH of the whole cocoa be 6.8 or less, desirably 5.0 to 6.0, when it is required to add cocoa.

Therefore, it is preferable that the addition amount of the alkaline cocoa (referred to as one having the pH of 6.8 or more in the present invention) be desirably 5% by weight or less with respect to the whole oily food material, and most desirably, the alkaline cocoa be substantially not contained.

(Compounding Amount of Basic Ingredient and Fat-Free Cacao Solid Material)

It is required to compound the cacao mass or the cocoa into the oily food material for combination use, but it is preferable that the compounding amount thereof be 8.5 to 25% by weight in terms of the fat-free cacao solid material, and desirably 10 to 20% by weight. However, the fat-free cacao solid material refers to the portion excluding cacao butter and water from the solid material derived from cacao beans.

(Compounding Amount of Basic Ingredient and Fat-Free Milk Solid Material)

A milk-derived basic ingredient may be compounded into the oily food material for combination use, but it is preferable that the compounding amount be desirably 7.5% by weight or less in terms of the fat-free milk solid material, and more preferably 4% by weight or less. However, the fat-free milk solid material refers to components other than milk fat and water which are derived from milk. Specific materials containing the fat-free milk solid material include milk, skim milk, concentrated milk, skimmed milk powder, whole milk powder, whey powder, and buttermilk powder.

(Basic Ingredient and Emulsifier)

A conventional emulsifying agent for water-in-oil-type emulsification can be appropriately used in the oily food material for combination use, but it is preferable contain 1.0 to 2.5% by weight, desirably 1 to 2.0% by weight, and more desirably 1.0 to 1.7% by weight as the total amount of one or more kinds of the emulsifying agents selected from lecithin or a polyglycerol condensed ricinolate. The polyglycerol condensed ricinolate may be abbreviated as PGPR.

Furthermore, it is desirable to add 0.7% by weight of lecithin alone and 1.5% by weight of PGPR alone as the upper limit. Furthermore, because PGPR has a stronger ability to reduce the viscosity than lecithin, desirably, it is desirable that PGPR is contained in the amount of 0.5% by weight or more.

As other basic ingredients, those, which are used for conventional water-in-oil-type emulsification, such as oils and fats, sugars, emulsifying agents, additives, and coloring agents can be appropriately used as long as the effects of the present invention are not impaired.

The oil and fat used in the oily food material for combination use with a frozen sweet of the present invention are not particularly limited as long as it is an edible oil and fat while satisfying the above-mentioned content of the oil and fat. Examples thereof include vegetable oils and fats such as rapeseed oil, soybean oil, sunflower seed oil, cottonseed oil, peanut oil, rice bran oil, corn oil, safflower oil, olive oil, kapok oil, sesame oil, evening primrose oil, palm oil, shea butter, sal butter, cacao oil, coconut oil, and palm kernel oil; and animal oils and fats such as milk fat, beef fat, lard, fish oil, and whale oil, and it is possible to use the above-mentioned oils and fats alone or mixed oils thereof, or processed oils and fats obtained by subjecting them to extreme hardening, fractionation, ester exchange, and the like. Since the oily food material of the present invention is for combination use with frozen sweets, it is desirable that the melting point of the oil and fat is low in terms of usage. When those with a high melting point are combined with frozen sweets, a melting sensation in the mouth tends to deteriorate.

(PH of Oily Food Material for Combination Use)

In addition to the pH of the basic ingredient derived from cacao as the basic ingredient, it is preferable that the pH of the oily food material for combination use be desirably 4.5 to 6.2, and more desirably 5.0 to 6.2. When the pH is high, the oily food material for combination use is likely to be become rough.

The pH of the oily food material for combination use can be measured with a commercially available pH meter by diluting it with water about 10 times.

(Production Step of Oily Food Material for Combination Use)

A method for producing the oily food material for combination use of the present invention is not particularly limited, and a known method can be adopted, but for example, it can be obtained by adding the residual aqueous component to an oily dough in which oily basic ingredients not containing water such as cacao-derived basic ingredient and oils and fats, and an oil-soluble emulsifying agent are added and kneaded, emulsifying using a homomixer, a colloid mill, a high-pressure homogenizer, or the like, and thereafter cooling and solidifying the emulsified product to obtain a mixture. However, it is desirable to provide a sterilization step at 68° C. or higher for 30 minutes or longer after emulsification.

In the present invention, although the oily food material for combination use can be obtained without the particular sterilization step, the sterilization step mandatory by law is required at the time of distribution and storage from the reason of food hygiene except when the oily food material for combination use is provided for immediate eating. When the oily food material is water-free, the influence of the sterilization step on the physical properties is small, which does not cause a problem, whereas the influence on the physical properties of conventional water-containing materials is large.

By using the method of the present application, the influence on the physical properties can be reduced even in the case of a water-containing material. It is practically difficult to store and distribute an oily food material for combination use for which a prescribed sterilization step is not provided. On the other hand, in the case of the water-free oily food material, the physical properties are not significantly impaired even in the above-mentioned sterilization step, but it is difficult to exhibit the freshness such as that of a water-containing material in terms of flavor.

(Frozen Sweet-Combined Food)

A frozen sweet-combined food can be obtained by combining the oily food material for combination use with a frozen sweet with a frozen sweet. A method of combining with the frozen sweet is not particularly limited, but examples thereof include application of spraying onto an object with a sprayer, kneading including dropwise addition usage in which the oily food material is coagulated by dropwise adding and mixing it in the frozen sweet such that the oily food material is present in the form of granules or fragments in the frozen sweet, and coating in which the surface of the frozen sweet is coated by immersing the frozen sweet in the oily food material in a melted state. When the physical properties are impaired without using the invention of the present application, there are an increase in the application amount and the coating amount, and the like, making it difficult to obtain a target product design.

### EXAMPLES

Hereinafter, examples of the present invention will be described to explain the present invention in more detail, but the spirit of the present invention is not limited to the following examples. In the examples, both % and parts mean on a weight basis.

<Series 1: Content of Oil and Fat>

### Example 1

A cacao mass A (natural cacao mass, pH 5.2), a vegetable oil and fat A (product name: soybean refined oil, FUJI OIL CO., LTD.), sugar, lecithin, and PGPR (trade name: CRS75, manufactured by Sakamoto Yakuhin Kogyo Co., Ltd.) were compounded according to Table 1 to produce a basic ingredient chocolate product according to the conventional method.

Subsequently, a high-fructose corn syrup (product name: HI FRUCT M-75, JAPAN CORN STARCH CO., LTD.) fresh cream (milk fat 47%, Meiji Co., Ltd.), and water were all mixed, and the mixture was heated to 50° C. and added to be mixed with the basic ingredient chocolate product obtained by the above-mentioned operation according to the compounding amount in Table 1.

While heating, the above-mentioned mixture was stirred with an anchor mixer (COMBI MIX Model 3M-5, PRIMIX Corporation), maintained at 68° C. for 30 minutes to be sterilized, and thereafter cooled at 5° C. to obtain a water-containing chocolate product which is an oily food material for combination use.

A method of combining with a frozen sweet was as follows: a commercially available square pillar-shaped ice bar (trade name: Vanilla Bar, manufactured by LOTTE CO., LTD., rough shape of ice part: 23 mm×23 mm×73 mm) of which the temperature had been adjusted to −18° C. was dipped up to a wood stick part in a glass beaker filled with the water-containing chocolate product that had been heated and melted to be adjusted to 40° C., and a chocolate-like food was coated therewith to be subjected to a texture test of a melting sensation in the mouth and a flavor.

The evaluation of the melting sensation in the mouth and the flavor is also shown in Table 1. A “natural cacao amount” in the table indicates the ratio (% by weight) of the whole occupied by the total of cacao mass and cocoa having the pH of 6.8 or less, and an “emulsifying agent amount” indicates the ratio (% by weight) of the whole occupied by the total amount of one or more kinds of the emulsifying agents selected from lecithin or a polyglycerol condensed ricinolate.

### Example 2, Example 3, and Comparative Example 1

Water-containing chocolate products were obtained by the same compounding and production step as in Example 1 except that the compounding amount of the vegetable oil and fat A of Example 1 was changed as shown in Table 1. The oil content was 45% by weight in Example 1, whereas it was 35% by weight in Example 2, and was 54% by weight in Example 3.

The viscosities of the obtained water-containing chocolate products were measured at 30 rpm/40° C. using a BM type viscometer No. 2 or No. 3.

TABLE 1

| | | | | | Comparative |
|---|---|---|---|---|---|
| | | Example 2 | Example 1 | Example 3 | Example 1 |
| Compounding | Cacao mass A | 26.9 | 27.0 | 27.0 | 22.6 |
| (parts by | Vegetable oil and fat A | 15.0 | 24.8 | 33.5 | 42.8 |
| weight) | Sugar | 31.9 | 22.0 | 22.0 | 17.0 |
| | Lecithin | 0.5 | 0.5 | 0.5 | 0.5 |
| | High-fructose corn | 11.6 | 11.6 | | |
| | syrup | | | | |
| | Fresh cream | 10.1 | 10.1 | 10.1 | 10.1 |
| | Water | 3.0 | 3.0 | 5.9 | 6.0 |
| | PGPR | 1.0 | 1.0 | 1.0 | 1.0 |
| Ratio | Fat-free cacao solid | 12.1 | 12.2 | 12.2 | 10.2 |
| (% by weight) | material | | | | |
| | Natural cacao amount | 26.9 | 27.0 | 27.0 | 22.6 |
| | Emulsifying agent | 1.5 | 1.5 | 1.5 | 1.5 |
| | amount | | | | |
| | Oil content | 34.3 | 44.2 | 52.9 | 59.8 |
| | Water content | 11.7 | 11.7 | 11.7 | 11.7 |
| Viscosity (Unit cP) | | 2400 | 810 | 650 | 350 |
| Evaluation | Melting sensation in | Good | Good | Slightly oily | Too oily and |
| | mouth and flavor | | | but good | unsurvivable |

In Example 1, Example 2, and Example 3, the water-containing chocolate products each having different oil contents were obtained, but the viscosities did not particularly hinder the operation of combining with the frozen sweets, and in Example 3, the water-containing chocolate product which was slightly oily but had sufficient melting sensation in the mouth and flavor, making the product able to survive in the market, was obtained. However, in Comparative Example 1, the oiliness was appeared strongly, resulting in the evaluation of unsurvivable in the market.

<Series 2: Oil and Fat Type and Viscosity>

### Example 4

Water-containing chocolate products were obtained by the same compounding and production step as in Example 2 except that the vegetable oil and fat A of Example 1 was changed to cocoa butter as shown in Table 2. The oil content was the same as in Example 2.

### Example 5 and Example 6

Water-containing chocolate products were created by the same compounding and production step as in Example 2 and Example 4 and sterilized under the same conditions except that the addition amount of PGPR of Example 2 and Example 4 was changed from 1% by weight to 1.5% by weight as shown in Table 2. The oil content was almost the same as in Example 2.

The viscosities of the obtained water-containing chocolate products were measured at 30 rpm/40° C. using a BM type viscometer No. 2 or No. 3, and an ice cream bar was coated therewith in the same manner as in Example 1 and subjected to the texture test of the melting sensation in the mouth and the flavor. The evaluation is shown in Table 2 together with the evaluation of Example 2.

TABLE 2

| | | Example 2 | Example 4 | Example 5 | Example 6 |
|---|---|---|---|---|---|
| Compounding | Cacao mass A | 26.9 | 26.9 | 26.9 | 26.9 |
| (parts by | Cocoa butter | | 15.0 | | 15.0 |
| weight) | Vegetable oil and fat | 15.0 | | 15.0 | |
| | A | | | | |
| | Sugar | 31.9 | 31.9 | 31.9 | 31.9 |
| | Lecithin | 0.5 | 0.5 | 0.5 | 0.5 |
| | High-fructose corn | 11.6 | 11.6 | 11.6 | 11.6 |
| | syrup | | | | |
| | Fresh cream | 10.1 | 10.1 | 10.1 | 10.1 |
| | Water | 3.0 | 3.0 | 3.0 | 3.0 |
| | PGPR | 1.0 | 1.0 | 1.5 | 1.5 |
| Ratio | Fat-free cacao solid | 12.1 | 12.1 | 12.0 | 12.0 |
| (% by weight) | material | | | | |
| | Natural cacao amount | 26.9 | 26.9 | 26.8 | 26.8 |
| | Emulsifying agent | 1.5 | 1.5 | 2.0 | 2.0 |
| | amount | | | | |
| | Oil content | 34.3 | 34.3 | 34.2 | 34.2 |
| | Water content | 11.7 | 11.7 | 11.6 | 11.6 |
| Viscosity (Unit cP) | | 2400 | 2300 | 1300 | 1300 |
| Evaluation | Melting sensation in | Good | Good | Good | Good |
| | mouth and flavor | | | | |

Although the oil and fat types used in Example 2 and Example 4 were different as the vegetable oil and fat A and the cocoa butter, there was no particular difference in physical properties. Regarding the flavor, the addition of the cocoa butter imparted a rich taste, but the original vegetable oil and fat A also imparted a clean flavor, thereby flattering the flavor of the cacao mass. The emulsion obtained by the cocoa butter was harder than that obtained by the vegetable oil and fat A, but had a sufficiently soft texture as compared to the water-free product.

In Example 5 with respect to Example 2, and in Example 6 with respect to Example 4, each of water-containing chocolate products in which the viscosity was further reduced by increasing the addition amount of PGPR was obtained, but by reducing the viscosity, the basis weight (the adhesion amount to the frozen sweet) was also stable, there was no particular problem in workability, and the influence of the emulsifying agent on the flavor of the final water-containing chocolate was not recognized. In addition, although a viscosity fluctuates greatly depending on the moisture absorption and basic ingredient compounding, it was shown that stable production is possible by adjusting the addition amount of PGPR.

<Series 3: Water Amount>

### Comparative Example 2, Example 7, Example 8, Example 9, and Comparative Example 3

Water-containing chocolate products were created by the same compounding and production step as in Example 1 and sterilized under the same conditions except that, as shown in Table 3, the compounding amount of water, or fresh cream in a case where changing only the compounding amount of water is not sufficient, was changed such that the water amount of Example 1 fluctuated, and compounding of the oil and fat A and the like was changed such that the oil content did not fluctuate. The water content was 0.8% by weight in Comparative Example 2, which was substantially 0, and it was 6.3% by weight in Example 7. In addition, for comparison, it was 11.7% by weight in Example 1, was 19.8% by weight in Example 8, was 25.3% by weight in Example 9, and was 29.7% by weight in Comparative Example 3.

The viscosities of the obtained water-containing chocolate products were measured by the same method as in Example 1 to perform the texture test of the melting sensation in the mouth and the flavor.

TABLE 3

| | | Comparative | Example | Example | Example | Example | Comparative |
|---|---|---|---|---|---|---|---|
| | | Example 2 | 7 | 1 | 8 | 9 | Example 3 |
| Compounding | Cacao mass A | 27.0 | 27.0 | 27.0 | 27.0 | 27.0 | 26.9 |
| (parts by | Vegetable oil and fat A | 29.6 | 27.2 | 24.8 | 23.2 | 19.9 | 24.8 |
| weight) | Sugar | 41.9 | 31.9 | 22.0 | 21.4 | 22.0 | 12.8 |
| | Lecithin | 0.5 | 0.5 | 0.5 | 0.5 | 0.5 | 0.5 |
| | High-fructose corn syrup | | 5.8 | 11.6 | 3.8 | | |
| | Fresh cream | | 5.1 | 10.1 | 10.1 | 10.1 | 10.1 |
| | Water | | 1.5 | 3.0 | 13.0 | 19.5 | 23.9 |
| | PGPR | 1.0 | 1.0 | 1.0 | 1.0 | 1.0 | 1.0 |
| Ratio | Fat-free cacao solid material | 12.2 | 12.2 | 12.2 | 12.2 | 12.2 | 12.1 |
| (% by | Natural cacao amount | 27.0 | 27.0 | 27.0 | 27.0 | 27.0 | 26.9 |
| weight) | Emulsifying agent amount | 1.5 | 1.5 | 1.5 | 1.5 | 1.5 | 1.5 |
| | Oil content | 44.5 | 44.3 | 44.2 | 42.6 | 39.3 | 44.1 |
| | Water content | 0.8 | 6.3 | 11.7 | 19.8 | 25.3 | 29.7 |
| Viscosity (Unit cP) | | 360 | 830 | 820 | 880 | 750 | Separated |
| Evaluation | Melting sensation | Poor | Little | Good | Good | Good but | — |
| | in mouth and flavor | melting | good | melting | melting | little fast | |
| | | sensation | melting | sensation | sensation | | |
| | | in mouth | sensation | in mouth | in mouth | | |
| | | | in mouth | | | | |

The water-containing chocolate products in which the water content increased from the one with the lowest water content in the order of Comparative Example 2, Example 7, Example 1, Example 8, Example 9, and Comparative Example 3 were obtained, but the water-containing chocolate product of Comparative Example 2 having no water content (0.8% by weight) had a poor melting sensation in the mouth, and did not go beyond the range of the conventional water-free type chocolate for ice coating. Subsequently, those of Example 7 (6.3% by weight), Example 1 (11.7% by weight), Example 8 (19.8% by weight), and Example 9 (25.3% by weight) showed a good melting sensation in the mouth, and clearly had superiority to the conventional water-free type. Meanwhile, as the water amount increased, the melting sensation in the mouth tended to become faster, which can be appropriately applied to the commercial product design.

However, in the case of Comparative Example 3 (29.7% by weight) in which the water amount was too large, the stability of emulsification was impaired, thereby separating oil and water, which made it impossible to perform the operation of ice coating itself

<Series 4: Emulsification Type>

### Example 10 and Comparative Example 4

Water-containing chocolate products of Example 10 (water-in-oil-type) and Comparative Example 4 (oil-in-water-type), which were similar to each other in terms of compounding except that the emulsification types were different (only whether the emulsifying agent was added or not was different since it acts on emulsification) as shown in Table 3, were created and sterilized under the same conditions.

The viscosities of the obtained water-containing chocolate products were measured by the same method as in Example 1 to perform the texture test of the melting sensation in the mouth and the flavor.

When the emulsions in a conductive state of Example 10 and Comparative Example 4 were examined before solidification with a tester (Digital Multimeter manufactured by KAISE CORPORATION), Example 10 did not show conductivity, but Comparative Example 4 was conductive, and therefore each of emulsification types thereof was confirmed as a water-in-oil-type and an oil-in-water-type.

TABLE 4

| | | | Comparative |
|---|---|---|---|
| | | Example 10 | Example 4 |
| Compounding | Cacao mass A | 27.0 | 27.0 |
| (parts by | Vegetable oil | 19.9 | 19.9 |
| weight) | and fat A | | |
| | Sugar | 22.0 | 23.0 |
| | Lecithin | 0.5 | 0.5 |
| | Fresh cream | 10.1 | 10.1 |
| | Water | 19.5 | 19.5 |
| | PGPR | 1.0 | |
| Ratio | Fat-free cacao | 12.2 | 12.2 |
| (% by weight) | solid material | | |
| | Natural cacao | 27.0 | 27.0 |
| | amount | | |
| | Emulsifying | 1.5 | 0.5 |
| | agent amount | | |
| | Oil content | 39.3 | 39.3 |
| | Water content | 25.3 | 25.3 |
| Viscosity (Unit cP) | | 750 | 8720 |
| Conductivity (emulsified type) | | Non-conductive | Conductive |
| | | (water-in-oil-type) | (oil-in-water-type) |
| Evaluation | Melting | Good but little | Good melting |
| | sensation in | fast | sensation in |
| | mouth and | | mouth but did not |
| | flavor | | solidify |

Although Example 10 and Comparative Example 4 had almost the same compounding except for the emulsification type, while both were good regarding the melting sensation in the mouth, Example 10 which was the water-in-oil-type became a good solidification (referred to as drying) state, whereas the viscosity increased in Comparative Example 4 which showed a slow drying time, and could not be used in terms of the commercial product design.

<Series 5: pH of Cocoa, Alkaline, Natural>

(Examples 11 and 12 and Comparative Examples 5 and 6) Water-in-oil-type water-containing chocolate products were created by the same compounding and production step as in Example 1 and sterilized under the same conditions except that, as shown in Table 5, a part of the solid material of the cacao mass was replaced with cocoa having a different pH under the condition in which the cacao solid material, and the oil content derived from cacao (that is, cocoa butter) were constant. The pH of the aqueous system of the water-containing chocolate product was 5.8 in Example 11, was 5.6 in Example 12, was 6.8 in Comparative Example 5, and was 7.6 in Comparative Example 6.

Each of cocoa A (commercially available natural cocoa, pH 5.5), cocoa B (commercially available alkaline cocoa, pH 7.0), and cocoa C (commercially available alkaline cocoa, pH 8.3) was used.

The viscosities of the obtained water-containing chocolate products were measured by the same method as in Example 1 to perform the texture test of the melting sensation in the mouth and the flavor.

TABLE 5

| | | | | Comparative | Comparative |
|---|---|---|---|---|---|
| | | Example 11 | Example 12 | Example 5 | Example 6 |
| Compounding | Cacao mass A | 27.4 | 2.5 | 2.5 | 2.5 |
| (parts by | Cocoa A | | 12.7 | | |
| weight) | Cocoa B | | | 12.7 | |
| | Cocoa C | | | | 12.7 |
| | Cocoa butter | | 12.2 | 12.2 | 12.2 |
| | Vegetable oil and | 25.2 | 25.2 | 25.2 | 25.2 |
| | fat A | | | | |
| | Sugar | 22.4 | 22.4 | 22.4 | 22.4 |
| | Lecithin | 0.2 | 0.2 | 0.2 | 0.2 |
| | High-fructose | 11.8 | 11.8 | 11.8 | 11.8 |
| | corn syrup | | | | |
| | Fresh cream | 10.2 | 10.2 | 10.2 | 10.2 |
| | Water | 3.0 | 3.0 | 3.0 | 3.0 |
| | PGPR | 1.0 | 1.0 | 1.0 | 1.0 |
| Ratio | Fat-free cacao | 12.2 | 12.3 | 12.3 | 12.3 |
| (% by weight) | solid material | | | | |
| | Natural cacao | 27.1 | 15.0 | 2.5 | 2.5 |
| | amount | | | | |
| | Emulsifying agent | 1.2 | 1.2 | 1.2 | 1.2 |
| | amount | | | | |
| | Oil content | 44.3 | 44.2 | 44.2 | 44.2 |
| | Water content | 11.7 | 11.3 | 11.3 | 11.3 |
| Water phase pH | | 5.8 | 5.6 | 6.8 | 7.6 |
| Viscosity (Unit cP) | | 520 | 340 | Separated | Separated |
| Evaluation | Melting sensation | Good | Good | — | — |
| | in mouth and | | | | |
| | flavor | | | | |

The pH was increased in the order from Example 11 of all natural cacao mass and Example 12 showing almost the same pH of an aqueous phase as that of Example 11 to Comparative Example 5 and Comparative Example 6 in which alkaline cocoa was added, and according to this increase, the stability of emulsification was impaired, thereby separating oil and water, which made it impossible to perform the operation of ice coating itself. Furthermore, although the water content and the oil content were the same and the pH was almost the same, since the viscosity of Example 12 in which the cocoa was used was low, the workability thereof was better than that of Example 11 in which the cacao solid material was provided only with the cacao mass, and because not only the flavor of the cacao mass alone but also the flavor of the cocoa, which has a different tendency from the cacao mass, could be felt, the degree of freedom of the commercial product was high in both cases.

<Series 6: pH of Aqueous Phase>

### Example 13, Comparative Example 7, Example 14, and Example 15

Water-in-oil-type water-containing chocolate products were created by the same compounding and production step as in Example 1 and sterilized under the same conditions except that, as shown in Table 6, citric acid, baking soda, and cocoa B were compounded to adjust the pH. The pH of the aqueous system of the water-containing chocolate product was 4.3 in Example 13, was 6.8 in Comparative Example 7, was 5.9 in Example 14, and was 6.2 in Example 15.

The viscosities of the obtained water-containing chocolate products were measured by the same method as in Example 1 to perform the texture test of the melting sensation in the mouth and the flavor.

TABLE 6

| | | | Comparative | | |
|---|---|---|---|---|---|
| | | Example 13 | Example 7 | Example 14 | Example 15 |
| Compounding | Cacao mass A | 27.0 | 27.0 | 27.4 | 27.4 |
| (parts by | Cocoa B | | | 5.0 | 10.0 |
| weight) | Vegetable oil and | 24.8 | 24.8 | 24.5 | 24.0 |
| | fat A | | | | |
| | Sugar | 21.0 | 21.0 | 21.0 | 21.0 |
| | Lecithin | 0.5 | 0.5 | 0.5 | 0.5 |
| | High-fructose | 11.6 | 11.6 | 6.5 | 1.0 |
| | corn syrup | | | | |
| | Fresh cream | 10.1 | 10.1 | 10.1 | 10.1 |
| | Water | 3.0 | 3.0 | 4.0 | 5.0 |
| | PGPR | 1.0 | 1.0 | 1.0 | 1.0 |
| | Citric acid | 1.0 | | | |
| | Baking soda | | 1.0 | | |
| Ratio | Fat-free cacao | 12.2 | 12.2 | 16.8 | 21.2 |
| (% by weight) | solid material | | | | |
| | Natural cacao | 27.0 | 27.0 | 27.4 | 27.4 |
| | amount | | | | |
| | Emulsifying agent | 1.5 | 1.5 | 1.5 | 1.5 |
| | amount | | | | |
| | Oil content | 44.2 | 44.2 | 44.1 | 43.6 |
| | Water content | 11.7 | 11.7 | 11.4 | 11.1 |
| Water phase pH | | 4.3 | 6.8 | 5.9 | 6.2 |
| Viscosity (Unit cP) | | 720 | Separated | 1550 | 2290 |
| Evaluation | Melting sensation | Good | — | Good | Slightly rough |
| | in mouth and | | | | |
| | flavor | | | | |

Example 13 (pH 4.3) and Example 14 (pH 5.9), in which the pH of the obtained water-containing chocolate was towards acidic, had a good melting sensation in the mouth, and although Example 15 (pH 6.2), which was towards slightly alkaline, had a slightly rough melting sensation in the mouth, it was at the level allowing a sufficient commercial product value. However, Comparative Example 7 (pH 6.8), which had a strong alkalinity, was separated, meaning that the quality was unsuitable for ice coating usage.

<Series 7: Fat-Free Cacao Solid Material>

### Examples 16 to 23 and Comparative Examples 8 and 9

Water-in-oil-type water-containing chocolate products were created by the same compounding and production step as in Example 1 and sterilized under the same conditions except that, as shown in Table 7, the compounding amounts of the cacao mass A and the cocoa A were adjusted. The fat-free cacao solid material of the water-containing chocolate product fluctuated from 4.4 to 20.9.

The viscosities of the obtained water-containing chocolate products were measured by the same method as in Example 1 to perform the texture test of the melting sensation in the mouth and the flavor.

TABLE 7

| | | Comparative | Comparative | Example | Example | Example |
|---|---|---|---|---|---|---|
| | | Example 8 | Example 9 | 16 | 17 | 18 |
| Compounding | Cacao mass A | 10.0 | | | 2.5 | 16.3 |
| (parts by | Cocoa A | | 7.0 | 10.0 | 11.2 | 5.0 |
| weight) | Vegetable oil and fat A | 34.8 | 39.5 | 39.2 | 38.9 | 31.3 |
| | Sugar | 27.8 | 27.8 | 27.8 | 22.4 | 22.4 |
| | Lecithin | 0.2 | 0.2 | 0.2 | 0.2 | 0.2 |
| | High-fructose corn syrup | 14.6 | 12.5 | 9.0 | 11.8 | 11.8 |
| | Fresh cream | 10.2 | 10.2 | 10.2 | 10.2 | 10.2 |
| | Water | 3.0 | 3.0 | 4.0 | 3.0 | 3.0 |
| | PGPR | 1.0 | 1.0 | 1.0 | 1.0 | 1.0 |
| Ratio | Fat-free cacao solid material | 4.4 | 6.2 | 8.8 | 11.0 | 11.6 |
| (% by | Natural cacao amount | 9.8 | 6.9 | 10.0 | 13.5 | 21.0 |
| weight) | Emulsifying agent amount | 1.2 | 1.2 | 1.2 | 1.2 | 1.2 |
| | Oil content | 44.2 | 44.3 | 44.3 | 45.6 | 44.9 |
| | Water content | 11.8 | 11.2 | 11.4 | 11.3 | 11.5 |
| Viscosity (Unit cP) | | Separated | Separated | 70 | 200 | 350 |
| Evaluation | Melting sensation | — | — | Bland | Good | Good |
| | in mouth and flavor | | | taste | | |

| | | Example | Example | Example | Example | Example |
|---|---|---|---|---|---|---|
| | | 19 | 20 | 21 | 22 | 23 |
| Compounding | Cacao mass A | 27.4 | 30.3 | 27.3 | 27.3 | 27.3 |
| (parts by | Cocoa A | | | 5.0 | 7.5 | 10.0 |
| weight) | Vegetable oil and fat A | 25.2 | 23.5 | 24.5 | 24.3 | 24.0 |
| | Sugar | 22.4 | 24.7 | 22.5 | 22.5 | 22.5 |
| | Lecithin | 0.2 | 0.2 | 0.2 | 0.2 | 0.2 |
| | High-fructose corn syrup | 11.8 | 7.3 | 6.5 | 3.8 | 1.0 |
| | Fresh cream | 10.2 | 10.2 | 10.2 | 10.2 | 10.2 |
| | Water | 4.0 | 3.0 | 3.0 | 4.0 | 5.0 |
| | PGPR | 1.0 | 1.0 | 1.0 | 1.0 | 1.0 |
| Ratio | Fat-free cacao solid material | 12.1 | 13.6 | 16.7 | 18.8 | 20.9 |
| (% by | Natural cacao amount | 26.8 | 30.2 | 32.2 | 34.6 | 36.9 |
| weight) | Emulsifying agent amount | 1.2 | 1.2 | 1.2 | 1.2 | 1.2 |
| | Oil content | 43.9 | 44.7 | 44.6 | 44.4 | 44.2 |
| | Water content | 12.5 | 10.8 | 10.6 | 11.0 | 11.3 |
| Viscosity (Unit cP) | | 560 | 1140 | 1180 | 2090 | 2500 |
| Evaluation | Melting sensation | Good | Good | Good | Good | Slightly |
| | in mouth and flavor | | | | | rough |

From Comparative Example 8 to Example 23 in which the amount of the fat-free cacao solid material fluctuated, in Comparative Examples 8 in which the fat-free cacao solid material was 4.4% by weight and Comparative Example 9 in which the fat-free cacao solid material was 6.2% by weight, separation occurred, making the commercial product value zero. In addition, although Example 16 with 8.8% by weight had disadvantages such as a decrease in the basis weight caused by a slightly low viscosity (70 cP), the melting sensation in the mouth and the flavor were good.

From Example 17 with 11.0% by weight to Example 21 with 16.7% by weight, the viscosity, and the melting sensation in the mouth and the flavor were good. Example 22 with 18.8% by weight and Example 23 with 20.9% by weight had good melting sensation in the mouth, flavor, and the like, but disadvantages such as an increase in the basis weight caused by a high viscosity (exceeding 2000 cP), and effects such as viscosity-dependent stickiness in the oral cavity beginning to become apparent were recognized; however, they were at the level that enables distribution as a commercial product.

<Series 8: Fat-Free Milk Solid Material>

### Examples 24 and 25

Water-containing chocolate products were created by the same compounding and production step and sterilized under the same conditions except that, as shown in Table 8, whole milk powder was added in Example 1, and a high-fructose corn syrup and water were changed such that the water content and the like were at the same level.

The viscosities of the obtained water-containing chocolate products were measured by the same method as in Example 1 to perform the texture test of the melting sensation in the mouth and the flavor. In addition, the compounding and the evaluation of Example 1 are also shown in Table 8 for comparison.

TABLE 8

| | | Example 1 | Example 24 | Example 25 |
|---|---|---|---|---|
| Compounding | Cacao mass A | 27.0 | 27.0 | 27.0 |
| (parts by weight) | Whole milk powder | | 5.0 | 10.0 |
| | Vegetable oil and fat | 24.8 | 24.0 | 23.8 |
| | A | | | |
| | Sugar | 22.0 | 21.2 | 20.1 |
| | Lecithin | 0.5 | 0.5 | 0.5 |
| | High-fructose corn | 11.6 | 7.3 | 4.5 |
| | syrup | | | |
| | Fresh cream | 10.1 | 10.1 | 10.1 |
| | Water | 3.0 | 3.9 | 3.0 |
| | PGPR | 1.0 | 1.0 | 1.0 |
| Ratio | Fat-free cacao solid | 12.2 | 12.2 | 12.2 |
| (% by weight) | material | | | |
| | Natural cacao amount | 27.0 | 27.0 | 27.0 |
| | Emulsifying agent | 1.5 | 1.5 | 1.5 |
| | amount | | | |
| | Oil content | 44.2 | 43.4 | 43.2 |
| | Water content | 11.7 | 11.7 | 10.2 |
| | Fat-free milk solid | 0.4 | 3.9 | 7.5 |
| | material | | | |
| Viscosity (Unit cP) | | 810 | 1100 | 930 |
| Evaluation | Melting sensation in | Good | Good | Little rough |
| | mouth and flavor | | | (had commercial |
| | | | | value) |

In Example 1 in which the fat-free milk solid material was 0.4% by weight and Example 24 in which it was 3.9% by weight, there was no particular problem in viscosity, melting sensation in the mouth, and flavor, whereas in Example 25 in which the fat-free milk solid material was 7.5% by weight, slight roughness was felt in the commercial product, although it was at the level allowing the commercial product value.

<Series 9: Lecithin>

### Example 26, Example 27, and Example 28

Water-containing chocolate products were created by the same compounding and production step as in Example 1 and sterilized under the same conditions except that, as shown in Table 9, the compounding of lecithin in Example 1 was changed.

### Example 29

Water-containing chocolate products were created by the same compounding and production step as in Example 1 and sterilized under the same conditions except that, as shown in Table 9, the PGPR of Example 1 was not added, and the compounding of lecithin was changed.

The viscosities of the water-containing chocolate products obtained in each of the examples were measured by the same method as in Example 1 to perform the texture test of the melting sensation in the mouth and the flavor. In addition, the compounding and the evaluation of Example 1 are also shown in Table 9 for comparison.

TABLE 9

| | | Example | Example | Example | Example | Example |
|---|---|---|---|---|---|---|
| | | 26 | 27 | 1 | 28 | 29 |
| Compounding | Cacao mass A | 27.0 | 27.0 | 27.0 | 27.0 | 27.0 |
| (parts by | Vegetable oil and fat A | 24.8 | 24.8 | 24.8 | 24.8 | 24.8 |
| weight) | Sugar | 22.5 | 22.3 | 22.0 | 21.8 | 22.3 |
| | Lecithin | | 0.2 | 0.5 | 0.7 | 1.2 |
| | High-fructose corn syrup | 11.6 | 11.6 | 11.6 | 11.6 | 11.6 |
| | Fresh cream | 10.1 | 10.1 | 10.1 | 10.1 | 10.2 |
| | Water | 3.0 | 3.0 | 3.0 | 3.0 | 3.0 |
| | PGPR | 1.0 | 1.0 | 1.0 | 1.0 | 0.0 |
| Ratio | Fat-free cacao solid material | 12.2 | 12.2 | 12.2 | 12.2 | 12.1 |
| (% by | Natural cacao amount | 27.0 | 27.0 | 27.0 | 27.0 | 27.0 |
| weight) | Emulsifying agent amount | 1.0 | 1.2 | 1.5 | 1.7 | 1.2 |
| | Oil content | 44.2 | 44.2 | 44.2 | 44.2 | 44.2 |
| | Water content | 11.7 | 11.7 | 11.7 | 11.7 | 11.7 |
| Viscosity (Unit cP) | | 700 | 560 | 820 | 980 | 2900 |
| Evaluation | Melting sensation | Good | Good | Good | Good | Good |
| | in mouth and flavor | | | | | |

The water-containing chocolate products in which the addition amount of the lecithin increased from the one with the lowest addition amount in the order of Example 26, Example 27, Example 1, and Example 28 were obtained, but the melting sensation in the mouth and the flavor were good in all cases. In addition, regarding the viscosity, only Example 28 (0.7% by weight of lecithin) was confirmed to have slight precipitation at the time of re-dissolution, but the quality was sufficient to survive use as a market product.

In Example 29, the water-containing chocolate product was created by increasing the amount of lecithin without adding PGPR, but the operation itself was possible although the viscosity was increased, and the melting sensation in the mouth and the flavor were good.

<Series 10: PGPR>

### Comparative Example 10 and Example 30

Water-containing chocolate products were created by the same production step as in Example 5 and sterilized under the same conditions except that the compounding shown in Table 10 was followed.

The viscosities of the obtained water-containing chocolate products were measured by the same method as in Example 5 to perform the texture test of the melting sensation in the mouth and the flavor. In addition, the compounding and the evaluation of Example 5 are also shown in Table 10 for comparison.

TABLE 10

| | | Comparative | | |
|---|---|---|---|---|
| | | Example 10 | Example 30 | Example 5 |
| Compounding | Cacao mass A | 11.6 | 11.6 | 26.9 |
| (parts by weight) | Cocoa A | 10.1 | 10.1 | |
| | Cocoa butter | 6.8 | 6.8 | |
| | Whole milk powder | 3.0 | 3.0 | |
| | Vegetable oil and fat A | 35.6 | 35.6 | 15.0 |
| | Sugar | 15.3 | 15.0 | 31.9 |
| | Lecithin | 0.3 | 0.3 | 0.5 |
| | High-fructose corn syrup | | | 11.6 |
| | Fresh cream | 10.1 | 10.1 | 10.1 |
| | Water | 6.7 | 6.7 | 3.0 |
| | PGPR | 0.5 | 0.8 | 1.5 |
| Ratio | Fat-free cacao solid | 14.2 | 14.2 | 12.0 |
| (% by weight) | material | | | |
| | Natural cacao amount | 21.7 | 21.7 | 26.8 |
| | Emulsifying agent amount | 0.8 | 1.1 | 2.0 |
| | Oil content | 47.6 | 47.6 | 34.2 |
| | Water content | 12.4 | 12.4 | 11.6 |
| Viscosity (Unit cP) | | 810 | 710 | 1300 |
| Evaluation | Melting sensation in mouth | There was | Good | Good |
| | and flavor | precipitation | | |

Precipitation was confirmed in Comparative Example 10 in which the compounding amount of the PGPR was 0.5% by weight. In Example 30 with 0.8% by weight, and also by setting the compounding amount of the PGPR to 1.5% by weight in Example 5 in which the oil content was reduced to 35% by weight which was lower than 55% by weight of Example 30, the melting sensation in the mouth was maintained in the good state, and the viscosity was also maintained in the good state of 1300 cP.

<Series 11: Whether or not Sterilization Step was Performed>

(Comparative Example 11, Example 31, Example 32, and Example 33) Water-containing chocolate products were obtained by the same compounding and production step as in Example 1 except that the addition amount of the PGPR was changed as shown in Table 11. Although the same method as in Example 1 was used, for the obtained water-containing chocolate products, the viscosity was measured before the sterilization step, the sterilization was performed under the same conditions, the viscosity was measured again, and the texture test of the melting sensation in the mouth and the flavor was performed to show the evaluation thereof in Table 11.

TABLE 11

| | | Comparative | | | |
|---|---|---|---|---|---|
| | | Example 11 | Example 31 | Example 32 | Example 33 |
| Compounding | Cacao mass A | 27.0 | 27.0 | 27.0 | 27.0 |
| (parts by | Vegetable oil and fat | 24.8 | 24.8 | 24.8 | 24.8 |
| weight) | A | | | | |
| | Sugar | 23.0 | 22.5 | 22.0 | 21.5 |
| | High-fructose corn | 11.6 | 11.6 | 11.6 | 11.6 |
| | syrup | | | | |
| | Fresh cream | 10.1 | 10.1 | 10.1 | 10.1 |
| | Water | 3.0 | 3.0 | 3.0 | 3.0 |
| | PGPR | 0.5 | 1.0 | 1.5 | 2.0 |
| Ratio | Fat-free cacao solid | 12.2 | 12.2 | 12.2 | 12.2 |
| (% by weight) | material | | | | |
| | Natural cacao amount | 27.0 | 27.0 | 27.0 | 27.0 |
| | Emulsifying agent | 0.5 | 1.0 | 1.5 | 2.0 |
| | amount | | | | |
| | Oil content | 44.2 | 44.2 | 44.2 | 44.2 |
| | Water content | 11.7 | 11.7 | 11.7 | 11.7 |
| Viscosity (before sterilization, cP) | | 570.0 | 700.0 | 570.0 | 490.0 |
| Viscosity (after sterilization, cP) | | — | 520 | 1140 | 810 |
| Evaluation | State after | Separated | Good | Good | Slightly |
| | sterilization | | | | separated |
| | Melting sensation in | — | Good | Good | Good |
| | mouth and flavor | | | | |

Although the melting sensation in the mouth was maintained in the good state up to Example 32 (1.5 by weight) and Example 31 (1.0% by weight) in which the addition amount of the PGPR was gradually reduced from Example 33 in which the addition amount was 2% by weight, whereas separation was recognized after the sterilization step, and a value as a commercial product was poor in Comparative Example 11 in which the addition amount was 0.5% by weight.

<Series 12: Types of Oil and Fat>

The vegetable oil and fat of Example 1 was changed from the soybean oil to other oils and fats to perform preparation. The vegetable oils and fats used are shown below.

Example 34: as a vegetable oil and fat B, 30.0 parts by weight of high oleic sunflower oil and 70.0 parts by weight of ethyl stearate were mixed, transesterification was performed thereafter using lipase having 1- and 3-position selectivity, and 13.0 parts by weight of a fractionated medium melting point oil and fat A (iodine value: 33.0, saturated fatty acid content: 64.2% by weight) which had undergone distillation, fractionation, decolorization, and deodorization, 5.0 parts by weight of a medium chain fatty acid triglyceride (iodine value: 0.5 or less, saturated fatty acid content: 100% by weight, fatty acids having 8 and 10 carbon atoms: 60:40), and 82.0 parts by weight of a corn oil (iodine value: 123.0, saturated fatty acid: 14.5% by weight) were mixed to perform a random transesterification reaction using sodium methylate as a catalyst. Thereafter, decolorization and deodorization were performed according to a conventional method to use the transesterified oil obtained as the refined oil.

Example 35: an extremely hardened coconut oil was used as a vegetable oil and fat C.

Example 36: a refined palm oil was used as a vegetable oil and fat D.

Example 37: as a vegetable oil and fat E, a palm olein oil (iodine value: 68.0, saturated fatty acid: 36.3 parts by weight) was subjected to a random transesterification reaction using sodium methylate as a catalyst, and thereafter decolorization and deodorization were performed according to a conventional method to use the transesterified oil obtained as the refined oil.

A water-containing chocolate product was obtained by the same production step as in Example 1. The texture test of the melting sensation in the mouth and the flavor was performed, and the evaluation thereof was shown in Table 12.

TABLE 12

| | | Example 1 | Example 34 | Example 35 | Example 36 | Example 37 |
|---|---|---|---|---|---|---|
| Compounding | Cacao mass A | 27.0 | 27.0 | 27.0 | 27.0 | 27.0 |
| (parts by | Vegetable oil and | 24.8 | | | | |
| weight) | fat A | | | | | |
| | Vegetable oil and | | 24.8 | | | |
| | fat B | | | | | |
| | Vegetable oil and | | | 24.8 | | |
| | fat C | | | | | |
| | Vegetable oil and | | | | 24.8 | |
| | fat D | | | | | |
| | Vegetable oil and | | | | | 24.8 |
| | fat E | | | | | |
| | Sugar | 22.0 | 22.0 | 22.0 | 22.0 | 22.0 |
| | Lecithin | 0.5 | 0.5 | 0.5 | 0.5 | 0.5 |
| | High-fructose | 11.6 | 11.6 | 11.6 | 11.6 | 11.6 |
| | corn syrup | | | | | |
| | Fresh cream | 10.1 | 10.1 | 10.1 | 10.1 | 10.1 |
| | Water | 3.0 | 3.0 | 3.0 | 3.0 | 3.0 |
| | PGPR | 1.0 | 1.0 | 1.0 | 1.0 | 1.0 |
| Ratio | Fat-free cacao | 12.2 | 12.2 | 12.2 | 12.2 | 12.2 |
| (% by weight) | solid material | | | | | |
| | Natural cacao | 27.0 | 27.0 | 27.0 | 27.0 | 27.0 |
| | amount | | | | | |
| | Emulsifying agent | 1.5 | 1.5 | 1.5 | 1.5 | 1.5 |
| | amount | | | | | |
| | Oil content | 44.2 | 44.2 | 44.2 | 44.2 | 44.2 |
| | Water content | 11.7 | 11.7 | 11.7 | 11.7 | 11.7 |
| Viscosity (Unit cP) | | 810 | 895 | 675 | 869 | 967 |
| Evaluation | Melting sensation | Good | Had rich | Had | Had slight | Had slight |
| | in mouth and | | taste and | hardness but | hardness but | hardness but |
| | flavor | | particularly | had | good | good |
| | | | good | commercial | | |
| | | | | value | | |

The water-containing chocolate products could be prepared with all the vegetable oils and fats. Although Example 35, in which the extremely hardened coconut oil which is the vegetable oil and fat C was used, had hardness, but had the commercial product value. The vegetable oil and fat B had a good melting sensation in the mouth, and the quality was good with a rich taste as a water-containing chocolate.

### Series 13: Coating onto Dairy-Free Frozen Dessert

A test of coating the entire surface of a dairy-free frozen dessert was performed using the coating chocolates of Examples 1, 21, and 34 obtained so far and of Comparative Example 12 which contained substantially no water.

The coating test was performed using the water-containing chocolate products and the chocolates.

The dairy-free frozen dessert to be coated was produced using “SHERBIC” (manufactured by House Foods Corp.).

Details are described below.

Water was put into one bag (65 g) of SHERBIC, agitated, adjusted to be Brix 36, poured into an ice-making mold, and cooled in a freezer set at −20° C. overnight.

The dairy-free frozen dessert removed from the mold was dipped in the water-containing chocolate product and the like of which the temperature had been adjusted to 40° C. to coat the entire surface. Table 14 shows the time required for solidification, and cracking of the water-containing chocolate product and the like on the coated surface.

Cracking indicates the state when leaving in the freezer set at −20° C. for 1 hour after coating and in the freezing set at −80° C. for 1 day, and thereafter storing in the freezing set at −25° C. for 3 days.

TABLE 13

| | | Comparative |
|---|---|---|
| | | Example 12 |
| Compounding | Cacao mass A | 1.6 |
| (parts by | Cocoa A | 16.2 |
| weight) | Whole milk powder | 9.3 |
| | Vegetable oil and fat | 45.2 |
| | Sugar | 27.2 |
| | Lecithin | 0.4 |
| | PGPR | 0.1 |

| | |
|---|---|
| Viscosity (Unit cP) | 1280 |

As a vegetable oil and fat, a blend of soybean oil:coconut oil:palm medium melting point fraction in the proportion of 1:5:7 was used.

TABLE 14

| | | | | Comparative |
|---|---|---|---|---|
| | Example 1 | Example 21 | Example 34 | Example 12 |
| Solidification | 18 (◯) | 17 (◯) | 14 (⊙) | 8 (⊙) |
| time (sec) | | | | |
| Basis weight | 2.5 | 2.9 | 2.4 | 2.1 |
| (g) | | | | |
| Cracking | 0/5 | 1/5 | 0/5 | 5/5 |
| Evaluation of | Acceptable | Acceptable | Acceptable | Unsuitable |
| cracking | | | | |

The solidification time indicates the time required for the water-containing chocolate product and the like used for coating to stop adhering to hands at room temperature.

◯ and ⊙ in parentheses indicate whether the state was good. ◯ indicates good, and ⊙ indicates better.

Regarding cracking, each of the water-containing chocolate products and the like was coated onto 5 dairy-free frozen desserts, and those with cracking on 2 or less out of 5 were regarded as acceptable.

The shape of the dairy-free frozen dessert is a shape made with a general ice-making mold.

Furthermore, the size of the top surface rectangle: 23 mm×25 mm, the bottom surface rectangle: 33 mm×35 mm, and the height: 25 mm.

All Examples 1, 21, and 34 had less cracking, and had the quality of an acceptable level.

Among them, Example 34 had no cracking and was excellent in solidification. The solidification times were inferior to that of Comparative Example 12, but the speed at which solidification started was good, and there were few problems of dripping of the chocolate products which is likely to occur in the coating, which was good.

In Comparative Example 12, although the solidification time was short, cracking occurred in all the dairy-free frozen desserts.

### INDUSTRIAL APPLICABILITY

The present invention relates to a method for producing a water-in-oil-type water-containing chocolate product for combination use with other foods, and can provide a method for producing a water-containing chocolate product for combination use particularly with a frozen sweet, the water-containing chocolate product having the same level of workability as that in the case where a water-free product is used while keeping a soft texture characteristic of a water-containing material, and remaining unchanged with respect to the physical properties thereof even when the water-containing chocolate product undergoes sterilization that is essential for the delivery thereof.

1. An oily food material for combination use which is a water-in-oil-type emulsion comprising:
a fat-free cacao solid material in an amount of 8.5 to 25% by weight;
cacao mass and cocoa each having a pH of 6.8 or less in a total amount of 10 to 40% by weight;
an oil or fat in an amount of 30 to 55% by weight;
water in an amount of 5 to 26% by weight; and
an emulsifying agent of one or more kinds selected from lecithin and/or a polyglycerol condensed ricinolate in a total amount of 1 to 2.5% by weight.

2. The oily food material for combination use according to claim 1, wherein a viscosity is 100 to 3000 cP (BM type viscometer No. 2 or No. 3, measurement at 30 rpm/40° C.).

3. The oily food material for combination use according to claim 1, wherein the oily food material for combination use has a pH of 4.5 to 6.2, has a fat-free milk solid material of 7.5% by weight or less, and is for combination use with a frozen sweet.

4. A method for producing the oily food material for combination use with a frozen sweet according to claim 1, the method comprising a sterilization step at 68° C. or higher for 30 minutes or longer after emulsification.

5. A method for producing a frozen sweet-combined food obtained by combining the oily food material for combination use with a frozen sweet according to claim 4 with a frozen sweet.

6. The oily food material for combination use according to claim 2, wherein the oily food material for combination use has a pH of 4.5 to 6.2, has a fat-free milk solid material of 7.5% by weight or less, and is for combination use with a frozen sweet.

7. A method for producing the oily food material for combination use according to claim 2, the method comprising a sterilization step at 68° C. or higher for 30 minutes or longer after emulsification.

8. A method for producing the oily food material for combination use according to claim 3, the method comprising a sterilization step at 68° C. or higher for 30 minutes or longer after emulsification.

9. A method for producing the oily food material for combination use according to claim 6, the method comprising a sterilization step at 68° C. or higher for 30 minutes or longer after emulsification.

10. A method for producing a frozen sweet-combined food obtained by combining the oily food material for combination use according to claim 7 with a frozen sweet.

11. A method for producing a frozen sweet-combined food obtained by combining the oily food material for combination use according to claim 8 with a frozen sweet.

12. A method for producing a frozen sweet-combined food obtained by combining the oily food material for combination use according to claim 9 with a frozen sweet.
